(19) United States
(12) Patent Application Publication
(10) Pub. No.: US 2016/0093891 A1
(43) Pub. Date: Mar. 31, 2016

(54) CERIUM OXIDE MODIFIED ORDERED MESOPOROUS CARBON CATALYST FOR FORMIC ACID OXIDATION IN DIRECT FORMIC ACID FUEL CELLS

(71) Applicant: King Fahd University of Petroleum and Minerals, Dhahran (SA)

(72) Inventors: Ateeq Ur REHMAN, Dhahran (SA); Shakeel Ahmed, Dhahran (SA); Mohammad Mozahar Hossain, Dhahran (SA); Sleem Ur Rahman, Dhahran (SA)

(73) Assignee: King Fahd University of Petroleum and Minerals, Dhahran (SA)

(21) Appl. No.: 14/496,889

(22) Filed: Sep. 25, 2014

(51) Int. Cl. H01M 4/86; H01M 4/92; H01M 8/10; H01M 4/90

(52) U.S. Cl. CPC H01M 4/8652; H01M 4/9016; H01M 4/921; H01M 4/926; H01M 8/1004; H01M 8/1018; H01M 2250/30; H01M 2008/1095; H01M 2300/0082

(57) ABSTRACT

Electrocatalysts for the anode electro-oxidation of formic acid in direct formic acid fuel cells (DFAFCs). The Pd-, Pt- or PdPt-based electrocatalysts contain CeO₂-modified ordered mesoporous carbon (OMC) as support material. Compositions and ratios of Pd:Pt in the electrocatalysts as well as methods of preparing and characterizing the catalysts and the CeO₂-OMC support material.

### BACKGROUND OF THE INVENTION

1. Technical Field

The present invention relates to electrocatalysts, particularly Pd and Pt-based electrocatalysts on a CeO₂-ordered mesoporous carbon support, their use in direct formic acid fuel cells for portable electronic device applications and a process of electro-catalytic oxidation of formic acid.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In recent years direct formic acid fuel cells (DFAFCs) have received growing interest as a compact generator, for electronic devices and transportation means. In a DFAFC, formic acid oxidation (FAO) takes place at the anode side while reduction occurs at the cathode side (Cynthia A R, Akshay B, Peter G P. Recent Advances in Electrocatalysis of Formic Acid Oxidation. Springer London, Lecture Notes in Energy 9(2013) 69-87—incorporated herein by reference in its entirety). Generally, the DFAFC offers the following major advantages: (1) safe and easy to handle, non-toxic, (2) can create high theoretical open circuit potential of 1.48 V which is larger than hydrogen (1.23 V) and methanol (1.21 V), and (3) low cross over through membrane than methanol and ethanol. Although formic acid has lower energy density (2104 Wh/L) compared to methanol (4900 Wh/L), the low cross over through the membranes allows the DFAFCs to operate at high formic acid concentrations (5-12 M) compared to methanol concentration (1-2 M), ensuing overall higher energy outputs (Cynthia A R, Akshay B, Peter G P. Recent Advances in Electrocatalysis of Formic Acid Oxidation. Springer London, Lecture Notes in Energy 9(2013) 69-87; Olumide W, Zhiyong Z, Changhai L, Wenzhen L., Electrochim. Acta 2011; 55(13): 4217-4221 W L Qu, Z B Wang, X L Sui, D M Gu, G P Yin, Fuel Cells 2013; 13 (2): 149-157; Zhiming C, Cheng G, Chun X G and Chang M L., J. Mater. Chem. A, 1(2013) 1179-1184—each incorporated herein by reference in its entirety).

In addition to the above technical advantages, mass scale applications of DFAFCs can also create opportunities of utilizing CO₂ (from fossil fuel combustion) as a source of formic acid production via electrochemical conversion of carbon dioxide (Charles D, Paul L. R, John B. K and John N., Electrochem. Soc. (2008); 155 (1): 42-49; Hui Li and Oloman, C. Continuous co-current clectrochemical reduction of carbon dioxide. WO2007041872 B1, 2007; Satoshi Y, Hiroshi H, Masahiro D, Yuji Z, Reiko H, Yuka Y, Momoko D, and Kazuhiro O., AIP Advances 2(2012) 042160; Richard R, Christian B and Bernhard R., Catalysts 2(2012) 544-571—each incorporated herein by reference in its entirety). This integrated approach not only offers DFAFCs as way of efficient energy generator but also contributes to the global efforts on the CO₂ utilization/sequestration, addressing the greenhouse gas effects (Charles D, Paul L. R, John B. K and John N., Electrochem. Soc. (2008); 155 (1): 42-49; Hui Li and Oloman, C. Continuous co-current clectrochemical reduction of carbon dioxide. WO2007041872 B1, 2007—each incorporated herein by reference in its entirety). The process of converting CO₂ to formic acid will be only economically viable if the energy demand for the electrochemical conversion of CO₂ to formic acid is supplemented from a renewable source such as solar energy. With the global efforts and recent advancements of the solar technologies, the outlook remains positive for this integrated approach (Satoshi Y, Hiroshi H, Masahiro D, Yuji Z, Reiko H, Yuka Y, Momoko D, and Kazuhiro O., AIP Advances 2(2012) 042160; Richard R, Christian B and Bernhard R., Catalysts 2(2012) 544-571—each incorporated herein by reference in its entirety).

In order to materialize the aforementioned advantages of DFAFCs, research and development efforts are underway. Despite some advancement, the present DFAFC systems suffer from some practical issues which need to be addressed in order to exploit their full benefits. The foremost drawback of the present DFAFCs is the use of expensive and scarce noble metal-based electrocatalysts to accelerate the slow kinetics of the anodic electro-oxidation of formic acid (Cynthia A R, Akshay B, Peter G P. Recent Advances in Electrocatalysis of Formic Acid Oxidation. Springer London, Lecture Notes in Energy 9(2013) 69-87; Olumide W, Zhiyong Z, Changhai L, Wenzhen L., Electrochim. Acta 2011; 55(13): 4217-4221; Yang L Jun, Su Neng, Ting and Shi Jun, Sci China Chem. 55(2012) 391-397; Feng, L G; Yang, J; Hu, Y; Zhu, J B; Liu, C P Xing, W., Int. J. Hydrogen Energ. 37(2012) 4812-4818; Yuan H Qin, Yue-J, Hou-H Y, Xin S Z, Xing G Z, Li N, Wei K Y., J. Power Sources 196 (10)(2011) 4609-4612—each incorporated herein by reference in its entirety). In addition to their high costs, the noble metal-based catalysts also suffer from severe poisoning due to the strong adsorption of the carbon monoxide (Haan J L, Masel R I, Electrochim. Acta 54(2009) 4073-4078—incorporated herein by reference in its entirety) and chemical instability in acidic environment. Among the noble metals, Pt and Pd are extensively studied as active components of the anode electrocatalysts. Although, Pd-based electrocatalysts showed higher catalytic activity for FAO reactions than Pt, it still lacks stability for the long period of operations (Yu Zhu, Yongyin K, Zhiqing Z, Qun Z, Junwei Z, Baojia X and Hui Y., Electrochem. Commun. 10(2008) 802-805; Xiao M Wang, Yong Y X., Electrochim. Acta 54(2009) 7525-7530—each incorporated herein by reference in its entirety). These difficulties warrant further research to develop highly durable and efficient Pd-based electrocatalysts for DFAFCs. In the open literature, various metals have been explored as promoter to enhance the catalytic activity and stability of Pd catalysts. The use of transition metals also helps reducing the use of noble metals in the catalyst formulation while maintaining or even improving the catalytic activity. The most common studied bimetallic catalysts include PdCo, PdNi, PdAu, PdPt, PtBi, PdSn and PdFe (Lu Zhang, Ling W, Yanrong Ma, Yu C, Yiming Z, Yawen T, Tianhong L., Appl. Catal. B, Environ. 138-139(2013) 229-235; Rongfang Wang, Hui W, Xingli W, Shijun L, Vladimir L and Shan J., Int. J. Hydrogen Energ. 38(2013) 13125-13131; Maja D., Obradovic, Sne, Gojkovi, Electrochim. Acta 88(2013) 384-389; Zhao, Zhua, Liuc and Wei Xing, Appl. Catal. B: Environ. 129(2013) 146-152; Zhang, Chun He, Jiang, Rao and Shi-Gang Sun, Electrochem. Commun. 25(2012) 105-108; DandanTu, Bing, Wang, Deng and Ying Gao, Appl. Catal. B: Environ. 103(2011) 163-168; Yanxian Jin, Chun'an M, Meiqin S, Youqun C, Yinghua X, Tao H, Qian H and Yiwai M., Int. J. Electrochem. Sci. 7(2012) 3399-3408—each incorporated herein by reference in its entirety).

Conventionally, the active metals/promoters are dispersed on a suitable support material to achieve highest possible catalytic activity using a minimum amount of metal. The supports also provide the required strength to the electrocatalyst in acidic environment of the fuel cells (Ermete Antolini., Appl. Catal. B: Environ. 88(2009) 1-24—incorporated herein by reference in its entirety). Like the conventional supported catalysts, high surface area, large pore volume and superior electrical conductivity of the support is highly desirable. The high surface area of the support allows better dispersion and less agglomeration of the nano-sized active metal particles, resulting in optimum catalytic performance. Among the studied support materials, large surface area carbon such as Vulcan XC72 carbon black is possibly the most widely used in electrocatalysts. With some advantages there are drawbacks of Vulcan XC72 carbon black supported electrocatalysts. Among those, the most important is non-contribution of some of the loaded expensive noble metals particles which are trapped in the deep cracks of the phase boundaries and micropores of the carbon black support (Yuyan Shao, Geping Y, Jiajun W, Yunzhi G and Pengfei S., J. Power Sources (2006); 161 (1): 47-53—incorporated herein by reference in its entirety). Carbon black also suffers from serious corrosion problems in the fuel cell oxidation operation (Sudong Yang, Xiaogang Z, Hongyu M, Xiangguo Y., J. Power Sources 175(2008) 26-32; Bruce R. R J. Frank R. M and Elton J. C., J. Electrochem. Soc. 142(1995) 1073-1084—each incorporated herein by reference in its entirety). In order to avoid these problems there are many other carbon materials have been investigated as electrocatalyst support, including carbon nanotubes (CNTs) (Olumide W, Zhiyong Z, Changhai L, Wenzhen L., Electrochim. Acta 2011; 55(13): 4217-4221; Zhiming C, Cheng G, Chun X G and Chang M L., J. Mater. Chem. A, 1(2013) 1179-1184; Yanxian Jin, Chun'an M, Meiqin S, Youqun C, Yinghua X, Tao H, Qian H and Yiwai M., Int. J. Electrochem. Sci. 7(2012) 3399-3408; Yuyan Shao, Geping Y, Jiajun W, Yunzhi G and Pengfei S., J. Power Sources (2006); 161 (1): 47-53; Sudong Yang, Xiaogang Z, Hongyu M, Xiangguo Y., J. Power Sources 175(2008) 26-32—each incorporated herein by reference in its entirety), nanofibers (CNFs) (Yuan H Qin, Yue-J, Hou-H Y, Xin S Z, Xing G Z, Li N, Wei K Y., J. Power Sources 196 (10)(2011) 4609-4612—incorporated herein by reference in its entirety) ordered mesoporous carbon (OMCs) (J. Zeng, C. Francia, C. Gerbaldi, V. Baglio, S. Specchia, A. S. Aricò, P. Spinelli., Electrochim. Acta 94(2013) 80-91; Sang H Joo, Seong J C, Ilwhan O, Juhyoun K, Zheng L, Osamu T & Ryong R., Nature 412(2001) 169-172; Sang Hoon Joo, Chanho P, Dae J Y, Seol-Ah L, Hyung I L, Ji M K, Hyuk C, Doyoung S., Electrochim. Acta 52(2006) 1618-1626; Zhi-Peng Sun, Xiao G Z, Hao Tong, Yan Y L, Hu L L., J. Colloid and Interf. Sci. 337(2009) 614-618; Juqin Zeng, Carlotta F, Mihaela A. D, Alessandro H. A. M V, Vijaykumar S. I, Stefania S, and Paolo S., Ind. Engg. Chem. Res. 51(2012) 7500-7509; Chuntao L, Meng C, Chunyu D, Jing Z, Geping Y, Pengfei S and Yongrong Sun., Int. J. Electrochem. Sci. 7(2012) 10592-10606—each incorporated herein by reference in its entirety), graphene (Seger B and Kamat P V., J. Phys. Chem. C (2009); 113(19): 7990-95—incorporated herein by reference in its entirety), metal carbides (Dong J H and Jae S L., Energies 2009; 2(4): 873-899—incorporated herein by reference in its entirety) among others.

Amongst the above support materials, ordered mesoporous carbons (OMCs) have found a wide range of potential applications due to their uniform pore structure, large pore volumes, high surface areas, superior electrical conductivity and good chemical stability (Zhang, Chun He, Jiang, Rao and Shi-Gang Sun, Electrochem. Commun. 25(2012) 105-108; J. Zeng, C. Francia, C. Gerbaldi, V. Baglio, S. Specchia, A. S. Aricò, P. Spinelli., Electrochim. Acta 94(2013) 80-91; Sang H Joo, Seong J C, Ilwhan O, Juhyoun K, Zheng L, Osamu T & Ryong R., Nature 412(2001) 169-172; Sang Hoon Joo, Chanho P, Dae J Y, Seol-Ah L, Hyung I L, Ji M K, Hyuk C, Doyoung S., Electrochim. Acta 52(2006) 1618-1626; Zhi-Peng Sun, Xiao G Z, Hao Tong, Yan Y L, Hu L L., J. Colloid and Interf. Sci. 337(2009) 614-618; Juqin Zeng, Carlotta F, Mihaela A. D, Alessandro H. A. M V, Vijaykumar S. I, Stefania S, and Paolo S., Ind. Engg. Chem. Res. 51(2012) 7500-7509; Chuntao L, Meng C, Chunyu D, Jing Z, Geping Y, Pengfei S and Yongrong Sun., Int. J. Electrochem. Sci. 7(2012) 10592-10606—each incorporated herein by reference in its entirety). When a suitable noble metal was deposited on OMCs, the resultant electrocatalysts showed excellent performances on methanol oxidations in a methanol fuel cell (J. Zeng, C. Francia, C. Gerbaldi, V. Baglio, S. Specchia, A. S. Aricò, P. Spinelli., Electrochim. Acta 94(2013) 80-91; Sang H Joo, Seong J C, Ilwhan O, Juhyoun K, Zheng L, Osamu T & Ryong R., Nature 412(2001) 169-172-incorporated herein by reference in its entirety). It has also been used as a support in a Pt-based electrocatalyst for formic acid fuel cell (Chuntao L, Meng C, Chunyu D, Jing Z, Geping Y, Pengfei S and Yongrong Sun., Int. J. Electrochem. Sci. 7(2012) 10592-10606-incorporated herein by reference in its entirety).

The modification of the ordered mesoporous carbon support material is also found beneficial to improve the activity of supported catalysts. The commonly used modifiers include TiO₂, WO₃, CeO₂, ZrO₂, NiO, and Fe₂O₃ metal oxides (W L Qu, Z B Wang, X L Sui, D M Gu, G P Yin, Fuel Cells 2013; 13 (2): 149-157; Yang L Jun, Su Neng, Ting and Shi Jun, Sci China Chem. 55(2012) 391-397; J. Zeng, C. Francia, C. Gerbaldi, V. Baglio, S. Specchia, A. S. Aricò, P. Spinelli., Electrochim. Acta 94(2013) 80-91; Min K J, Jung Y W, Ki R L, Seong I W., Electrochem. Commun. 9(2007) 2163-2166; Gumaa El-Nagar, Ahmad M. Mohammad, El-Deab and El-Anadouli, Electrochim. Acta 94(2013) 62-71; Hao An, Cui, Zhou and Dejing Tao, Electrochim. Acta 92 (2013) 176-182—each incorporated herein by reference in its entirety). Partially filled d- or f-orbital of the transition metals allow them to switch between valences. Metal oxide-carbon composites have been extensively investigated as support material for methanol oxidation electrocatalysts (W L Qu, Z B Wang, X L Sui, D M Gu, G P Yin, Fuel Cells 2013; 13 (2): 149-157; Yang L Jun, Su Neng, Ting and Shi Jun, Sci China Chem. 55(2012) 391-397; J. Zeng, C. Francia, C. Gerbaldi, V. Baglio, S. Specchia, A. S. Aricò, P. Spinelli., Electrochim. Acta 94(2013) 80-91; Min K J, Jung Y W, Ki R L, Seong I W., Electrochem. Commun. 9(2007) 2163-2166; Gumaa El-Nagar, Ahmad M. Mohammad, El-Deab and El-Anadouli, Electrochim. Acta 94(2013) 62-71; Hao An, Cui, Zhou and Dejing Tao, Electrochim. Acta 92 (2013) 176-182—each incorporated herein by reference in its entirety). These studies showed that the addition of metal oxide improves both the activity and stability of the catalysts. There are other reports discussing the modification effects of NiO, WO₃ and CeO₂ on Pd/Pt—C for FAO (Yang L Jun, Su Neng, Ting and Shi Jun, Sci China Chem. 55(2012) 391-397; J. Zeng, C. Francia, C. Gerbaldi, V. Baglio, S. Specchia, A. S. Aricò, P. Spinelli., Electrochim. Acta 94(2013) 80-91; Gumaa El-Nagar, Ahmad M. Mohammad, El-Deab and El-Anadouli, Electrochim. Acta 94(2013) 62-71—each incorporated herein by reference in its entirety). In general, the addition of the transition metal oxides improves the overall performance of the carbon supported Pd-based electrocatalysts. Among these metal oxides, CeO₂ is widely used as reducible oxide having high oxygen carrying capacity. The Ce⁴⁺/Ce³⁺ couples (by redox cycles) release oxygen in different conditions, which enhance the electro-oxidation abilities of Pt/C catalysts (Rui L, Chunhui C, Haiyan Z, Huibo H, Jianxin M., Int. J. hydrogen energ. 37(2012) 4648-4656-incorporated herein by reference in its entirety). Wang et al. (Yi Wang, Shuangyin W and Xin W., Electrochem. Solid St. (2009); 12 (5): B73-B76—incorporated herein by reference in its entirety) demonstrated superior activity of Pd/CeO₂—C electrocatalysts as compare to Pd/C in a formic acid fuel cell. Wang et al. suggested that the presence of CeO₂ promotes the direct oxidation pathway (dehydrogenation) instead of the dehydration pathway. As a result, the overall performance of the catalyst was improved. Yang et al. (Yang L Jun, Su Neng, Ting and Shi Jun, Sci China Chem. 55(2012) 391-397—incorporated herein by reference in its entirety) considered that the improved catalytic activity was due to the oxygen vacancies provided by CeO₂ for the further oxidation of CO-like species, which previously poisoned the active Pt sites by CO chemisorptions. Feng et al. (Feng, L G; Yang, J; Hu, Y; Zhu, J B; Liu, C P Xing, W., Int. J. Hydrogen Energ. 37(2012) 4812-4818—incorporated herein by reference in its entirety) showed 1.67 times higher peak current density when a Pd/C sample was modified with CeO₂. The CeO₂ modified electrocatalysts also remained stable for longer (seven times) period of time. Feng et al. also attributed the improved performance to the higher electrochemical surface area (ECSA), the electronic effect, and presence of oxygen containing CeO₂ composite. To the knowledge of the authors, there is no report available in the open literature demonstrating the performance of CeO₂-OMC (ordered mesoporous carbon) composite as support material for Pt/Pd-based formic acid oxidation electrocatalyst.

In view of the foregoing, the need for improvements in CeO₂-modified OMC as support material for Pd/Pt-based electrocatalyst for formic acid oxidation in DFAFCs and the need for improvement to Pd/Pt-based electrocatalyst for formic acid oxidation can readily be appreciated

### BRIEF SUMMARY OF THE INVENTION

The foregoing paragraphs have been provided by way of general introduction, and are not intended to limit the scope of the following claims. The described embodiments, together with further advantages, will be best understood by reference to the following detailed description taken in conjunction with the accompanying drawings.

In a first aspect, the present invention provides an electrocatalyst for a fuel cell electrode comprising Pd as a first catalytic metal, Pt as a second catalytic metal and

mesoporous carbon comprising CeO₂ as catalyst support material. Pd and Pt are present in a ratio of x:y, x>y and x and y are optionally independently 1, 2, 3, 4 or 5. Pd and Pt are disposed in the mesopores of the mesoporous carbon in the electrocatalyst.

In a preferred embodiment, Pd, Pt, CeO₂ and mesoporous carbon in the electrocatalyst are nanoparticles. Pd and Pt are present in an amount of no greater than 30% of the total weight of the catalyst.

In one embodiment, the electrocatalyst catalyzes the oxidation of formic acid to form CO₂.

In a second aspect, the present invention provides a direct formic acid fuel cell (DFAFC) comprising an anode comprising a catalyst comprising particles of Pd or Pt or both, a cathode, an electrolyte disposed between the anode and the cathode, a formic acid solution in contact with the anode and a solution comprising at least one oxidizing agent in contact with the cathode.

The anode catalyst of the fuel cell anode further comprises a carbon support, wherein the carbon support can be chosen from carbon black, ordered or disordered carbon nanotubes, ordered or disordered carbon nanofibers, ordered or disordered mesoporous carbon, graphene, metal carbides and silicon carbide. A preferred embodiment of the carbon support is ordered mesoporous carbon (OMC).

The carbon support may be modified a metal oxide, such as TiO₂, WO₃, CeO₂, ZrO₂, NiO, and Fe₂O₃. In a preferred embodiment, the metal oxide is CeO₂.

Different ratios of Pd:Pt in the anode catalyst and the effects on the physical and chemical properties of the variations are also disclosed. The effects of the CeO₂ modification of the OMC support are also explored through these characterizations. In general, the CeO₂ modification is found to increase the specific surface area of the OMC and electrochemical active surface area of the anode catalyst, enhance the uniformed dispersion of Pd and Pt on the OMC surface, increase the electrocatalytic activities and long-term stability of the anode catalyst for formic acid oxidation and minimize CO poisoning effects on the catalyst.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an embodiment of a direct formic acid fuel cell (DFAFC) incorporating a PdₓPt_{y}/CeO₂-OMC or PdₓPt_{y}/OMC according to the present invention as the anode electrocatalyst.

FIG. 2 is a graph illustrating wide angle XRD pattern of CeO₂-OMC support, Pd/OMC and PdPt/CeO₂-OMC catalysts with varying ratios of Pt and Pd.

FIG. 3a is a TEM image of Pd/CeO₂-OMC.

FIG. 3b is an image of Pd₃Pt₁/CeO₂-OMC.

FIG. 3c is an image of Pd₁Pt₃/CeO₂-OMC.

FIG. 3d is an image of Pt/CeO₂-OMC.

FIG. 4a is an SEM image of CeO₂-OMC.

FIG. 4b is an SEM image of Pd₃Pt₁/CeO₂-OMC.

FIG. 4c is an EDX image of Pd₁Pt₃/CeO₂-OMC.

FIG. 4d is an EDX image of Pt/CeO₂-OMC.

FIG. 5 illustrates TGA curves of (A) CeO₂-OMC (B) Pd₃Pt₁/CeO₂-OMC at 10° C./min.

FIG. 6 illustrates N₂ adsorption-desorption isotherm and BJH pore size distribution of OMC, CeO₂-OMC, Pd/CeO₂-OMC, Pd₃Pt₁/CeO₂-OMC, Pd₁Pt₃/CeO₂-OMC and Pt/CeO₂-OMC.

FIG. 7a illustrates the first and second cycles of CO stripping measurements for PdPt/CeO₂-supported electrocatalysts in 0.5 M H₂SO₄ at a scan rate of 20 mV/s, wherein (a) is Pd/OMC, (b) is Pd/CeO₂-OMC, (c) is Pd₃Pt₁/CeO₂-OMC, (d) is Pd₁Pt₃/CeO₂-OMC and (e) Pt/CeO₂-OMC.

FIG. 7b is an enlargement of the CO oxidation peaks in FIG. 7a.

FIG. 8a illustrates cyclic volammetry (CV) patterns of Pd/OMC, Pd/CeO₂-OMC and PdPt/CeO₂-OMC electrocatalysts with various Pd:Pt ratios in 0.5 M H₂SO₄+0.5 M HCOOH solution.

FIG. 8b is a bar graph showing maximum currents during CV patterns of Pd/OMC, Pd/CeO₂-OMC and PdPt/CeO₂-OMC electrocatalysts with various Pd:Pt ratios in 0.5 M H₂SO₄+0.5 M HCOOH solution.

FIG. 9 illustrates chronoamperometry at 0.3 V (vs. Ag/AgCl) for Pd/OMC and PdPt/CeO₂-OMC electrocatalysts in the N₂-saturated 0.5 M H₂SO₄ and 0.5 M HCOOH solution.

### DETAILED DESCRIPTION OF THE EMBODIMENTS

Referring now to the drawings, wherein like reference numerals designate identical or corresponding parts throughout the several views.

The present invention is directed to Pd and/or Pt-based electrocatalysts for formic acid oxidation in direct formic acid fuel cells (DFAFCs).

For purposes of the present invention, a DFAFC is a subtype of proton exchange membrane or polymer electrolyte membrane fuel cell (PEMFC). PEMFCs operate on a relatively simple principle of extracting protons and electrons from hydrogen atoms.

At the anode, hydrogen is broken down to yield a single proton and single electron. The source of the hydrogen for this step is what determines the subtype of PEMFC. For example, formic acid is used in formic fuel cells while hydrogen derived from methanol is used in methanol fuel cells (whether direct or indirect). After the proton and electron are separated, the proton is free to travel through the polymer electrolyte membrane (PEM). The PEM may be made of polymeric materials and acids such as perfluorosulfonic acid, which acts as the electrolyte in these fuel cells. The proton moves to the cathode side of the fuel cell, leaving the electron behind. The electron is unable to cross the PEM and as a result cannot reach the cathode, which is now positively charged due to the migration of protons through the PEM. This difference in charges sets up an electrochemical gradient, which is commonly referred to as a voltage. Once an external circuit is created, the voltage is then leveraged to move electrons through the circuit to the cathode. Precious metals such as palladium and platinum are often used to catalyze the redox reactions at the electrodes, so that PEMFCs can operate at relatively low temperatures (less than 40° C. to 250° C.).

For purposes of the present invention, in a DFAFC, the fuel, formic acid is fed directly to the fuel cell, thus removing the need for complicated catalytic reforming of the fuel.

For purposes of the present invention, “catalyst” and “electrocatalyst” are used interchangeably to refer to a catalyst in a fuel cell.

In one embodiment, the electrocatalyst may consist essentially of Pd particles.

In one embodiment, the electrocatalyst may consist essentially of Pt particles.

In another preferred embodiment, the catalyst may be bimetallic, containing a combination of Pt and Pd particles optionally at a specific ratio of x:y, wherein x is preferably greater than y. In some embodiments, the Pd:Pt ratio may be 1:1, 1:2, 1:3, 1:4, 1:5, 5:1, 4:1, 3:1 or 2:1.

In one embodiment, the Pd and Pt particles are nanoparticles, with an average particle diameter of 1-10 nm, preferably no greater than 5 nm, and preferably having an average particle diameter of from 2 to 4 nm. In other embodiments the Pd and Pt nanoparticles have a particle size distribution such that more than 95%, preferably more than 98 or more than 99% of the particles have a particle size of less than 10 nm.

In some embodiments, disclosed electrocatalysts further include a carbon support material. Examples of the carbon support material include carbon black, ordered or disordered carbon nanotubes, ordered or disordered carbon nanofibers, ordered or disordered mesoporous carbon, graphene, metal carbides, silicon carbide. In one embodiment, the carbon support material is ordered mesoporous carbon (OMC).

In certain embodiments, the OMC may be modified with a metal oxide, for example, TiO₂, WO₃, CeO₂, ZrO₂, NiO, and Fe₂O₃. In one embodiment, CeO₂ is the modifier.

For purposes of the present invention, a “mesoporous material” is a material containing pores with diameters between 2 and 50 nm. “Microporous materials” have pore diameters of less than 2 nm. “Macroporous materials” have pore diameters of greater than 50 nm.

According to the present invention, both the unmodified and CeO₂-OMC may have a BET specific surface area of 800-1000 m² g⁻¹, preferably 1000-1500 m² g⁻¹, a most preferable pore size of 2-8 nm, preferably 3-4 nm, a pore volume of 0.4-3.2 cm³ g⁻¹, preferably 1.0-1.5 cm³ g⁻¹.

The OMC may be commercially available (for example, a trade name of CMK-1 or CMK-3, as a commercially available OMC having an ordered pore structure), or may be produced by a known process (for example, reference can be made according to Journal of Materials Chemistry, Vol. 19, 2009, pp. 7759-7764—incorporated herein by reference in its entirety).

There is no special limitation as to the particle size of the mesoporous carbon, as long as it meets with the requirements as set for a carrier in a catalyst. For example, the particle size could be, but not limited to, 10 to 10000 nm, or 10 to 1000 nm, or 10 to 100 nm. When the mesoporous carbon is of a non-spherical shape, a person skilled in the art will recognize that the particle size refers to the size of long axis or length.

In a preferred embodiment, the disclosed catalyst is a nanocatalyst, wherein all catalytic, non-catalytic, metal and non-metal particles used are nanoparticles.

The present invention also provides methods of forming OMC. A preferred method involves the initial formation of a silica template or precursor with ordered mesoporous silica. Examples of ordered mesoporous silica include but are not limited to SBA-15, TUD-1, MCM-41, HMM-33 and FSM-16. In one embodiment, the present invention further provides methods of synthesizing ordered mesoporous silica templates. For example, SBA-15 may be prepared by polymerization of TEOS using the hard template method. OMC is then synthesized via carbonization of sucrose mesopores of SBA-15 followed by the hydrofluoric acid (HF) treatment to remove the unconverted silica traces completely.

Preferably, the synthesized SBA-15 is modified with CeO₂. The SBA-15 may be modified by wetness impregnation method using Ce(NO₃)₃.6H₂O as cerium precursor to produce the intermediate CeO₂-SBA-15 prior to the synthesis of CeO₂-OMC.

Methods also include preparation of OMC or CeO₂-OMC supported Pt and/or Pd-based electrocatalysts. In one embodiment, the amount of OMC may be 65-99 wt. % of the catalyst, preferably 75-85 wt. %. The amount of Ce may be 5-15 wt. % of the catalyst, preferably 7-10 wt. %. Methods of loading the catalytic metals onto the OMC or CeO₂-OMC support include direct doping, wet impregnation, hydrolysis impregnation and chemical vapor deposition (CVD).

Dispersion may be improved, for example, through improved nanoparticle preparation methods to prevent particle agglomeration and/or reduce nanoparticle size. In synthesis methods of the present invention, Pd and Pt nanoparticles are prepared by dissolving a metal salt in solution and adding a reducing agent, such as NaBH₄, which reduces Pd(²⁺) to Pd metal nanoparticles. Pd and Pt metal precursors may also be solvated in water with ethylene glycol and metals may be reduced at a temperature of 300-400° C. under 7% H₂/N₂ or 4% H₂/Ar gas flow (Xiulei J, Tae L, Reanne H. Lei Z, Jiujun Z, Gianluig A. B, Martin C. and Linda F. N. Nature Chemistry 4(2010): 286-293; Jongmin S., Jaehyuk L., Youngjin Y., Jongkook H., Soo-Kil K., Tae-Hoon L, Ulrich W. and Jinwoo L. ACS Nano 6(2012) 6870-6881—each incorporated herein by reference in its entirety). Pd and/or Pt nanoparticles are then loaded upon the OMC or CeO₂-OMC support. The size of the Pd and Pt nanoparticles will depend upon the strength of the reducing agent, the solvents used, the temperature, the stabilizing polymers used, etc. Once the nanoparticles are formed they typically have a surface charge on them.

The dispersion increases quickly as the particle size shrinks. To achieve increased activity, other catalysts of the invention will have substantially all of the Pd and Pt nanoparticles of a size less than about 10 nm, and still other catalysts of the invention with substantially all Pd and Pt nanoparticles of a size less than about 5 nm. Exemplary catalysts of the invention having Pd and Pt particle sizes of about 2 nm will result in a dispersion of 25-30% and exemplary catalysts with a Pd/Pt particle size of about 1.2-1.5 nm will achieve dispersions of greater than 50%. Therefore, Pd and Pt nanoparticles have a dispersion of 25-60%, preferably 40-60%. Smaller particle sizes are also believed to improve binding energy of formic acid and hydrogen to the catalyst.

In one embodiment, the total amount of Pd and Pt may be 0-30 wt. % of the catalyst, preferably 5-25 wt. %, 10-20 wt. %, or about 15 wt. %.

In another embodiment, the amount of Pd may be 0-15 wt. % of the catalyst, preferably 2-14 wt. %, 6-13 wt. % or about 10 wt. %.

In yet another embodiment, the amount of Pt may be 0-15 wt. % of the catalyst, preferably 2-13 wt. %, 7-12 wt. % or 7-8 wt. %.

Methods provided herein further include methods of characterizing the physical and electrochemical properties of the synthesized catalysts. Physical properties such as morphology, structural properties, compositions of the PdPt/CeO₂-OMC catalysts may include scanning electron microscopy (SEM), thermo gravimetric analysis (TGA), X-ray diffraction (XRD), transmission electron microscopy (TEM), N₂ adsorption/desorption isotherm, energy dispersive X-ray spectroscopy (EDX).

It is noted that Pd- and Pt-based catalysts when used with formic acid fuel cells can become poisoned over time and thereby show some decreased activity. It is suspected that OH or other poisoning species may become bound to catalytic sites, thereby making them unavailable for future catalytic activity. Addition of certain metals may prevent or reduce the poisoning. When a carbon support material is used for Pd- and Pt-based catalysts, the metals in their oxidized form may be incorporated within the support material. Therefore, electrochemical active surface area (ECAS) and CO poisoning resistance of the catalyst samples as well as the effects of CeO₂ addition may be determined by CO stripping voltammetry. In one embodiment, the synthesized electrocatalysts with CeO₂-modified OMC support have an ECAS of at least 50 m²/g metal, preferably 20-50 m²/g metal or 30-40 m²/g metal.

Also, it has been discovered that the poisoning effects can be largely reversed and the poisoning species removed through application of high potential. Thus, for example, it may be useful when operating a formic acid fuel cell of the invention with a Pd/Pt catalyst to intermittently apply a high potential to “clean” the catalysts of poisoning species.

Electrochemical characterizations of the catalysts may also include determination of formic acid oxidation (FAO) activity, catalytic activity and stability. FAO of the CeO₂-modified OMC-supported electrocatalysts may be established via cyclicvolammetry (CV) analysis. Chronoamperometry analysis may be employed to study the catalytic activity and stability of the various embodiments of the CeO₂-modified OMC-supported Pd- and/or Pt-based electrocatalysts towards HCOOH electro-oxidation.

In one embodiment, a CeO₂-modified OMC-supported electrocatalyst may display a current density of 10-80 mA/cm², preferably 50-80 mA/cm² and a maximum current of 30-100 mA/cm², preferably 40-80 mA/cm². Power outputs of up to 50 mW/cm², preferably 15-30 mW/cm², may be produced by a DFAFC incorporating a CeO₂-modified OMC-supported electrocatalyst according to the present invention.

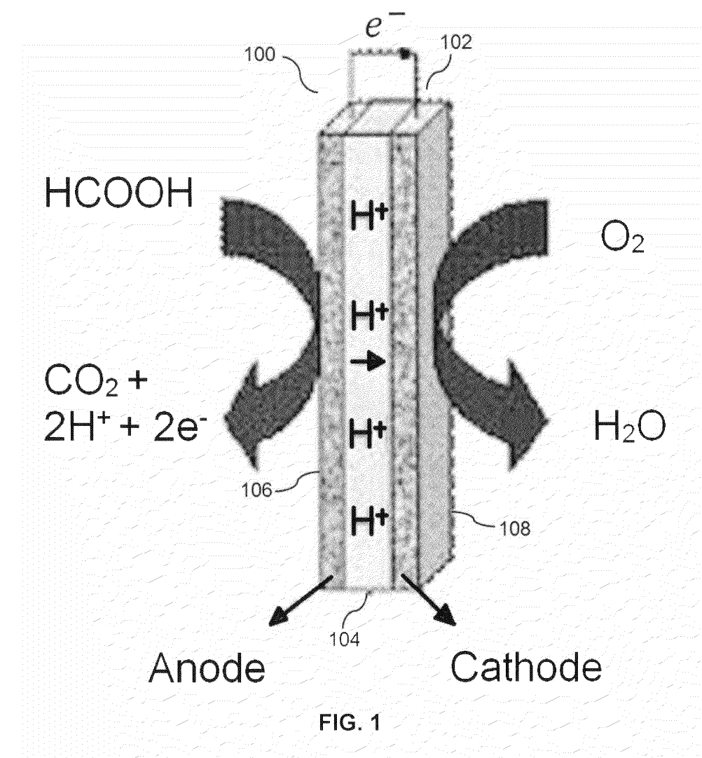

Additionally, the present invention relates to a direct formic acid fuel cell (DFAFC) having a PdₓPt_{y}/CeO₂-OMC, wherein x and y are preferably up to 5, and optionally independently=0, 1, 2, 3, 4 or 5 and x is preferably greater than y. As shown in FIG. 1, DFAFC 100 includes a membrane electrode assembly (MEA) 102. MEA 102 includes a polymer electrolyte membrane (PEM) membrane 104 saturated with at least 18.0 wt. % of the total PEM membrane weight, preferably 0.40-0.60 wt. %. The PEM membrane 104 is flanked by an anode catalyst layer 106 disposed on a first surface of the MEA and a cathode catalyst layer 108 disposed on a second surface of the MEA. A PdₓPt_{y}/CeO₂-OMC or PdₓPt/OMC electrocatalyst according to the present invention may be used as the anode catalyst layer, where formic acid of concentrations up to 15M (preferably 5-12 M) may be oxidized. Protons (H⁺) produced during the oxidation are passed through the PEM membrane to react with oxygen on the cathode catalyst layer located on a second surface of the PEM membrane.

Electrons produced during the oxidation of formic acid are passed through an external circuit from anode to cathode to provide power to an external device. Oxygen is reduced to water at the cathode.

The oxidation reaction (formic acid oxidation) that occurs at anode catalyst layer 106 is:

HCOOH→CO₂+2H⁺+2e⁻

At cathode catalyst layer 108, the reduction reaction is as follows:

O₂+2H⁺+2e⁻→H₂O

In one embodiment, a solid polymer electrolyte such as the PEM membrane may be responsible for the selective conduction of protons, separation of product gases and electrical insulation of the electrodes. PEM membranes may be constructed of either polymer membranes or composite membranes where other materials are embedded in a polymer matrix. Examples of PEM materials include but are not limited to PFSA fluoropolymer, Nafion®, polyethyleneimine (PEI)/SiO2 with amine/trifluoromethanesulfonimide (HTFSI).

In one embodiment, conventional electrolyte solutions may be used. Electrolyte solutions may contain ions such as Na⁺, K⁺, Ca²⁺, Mg²⁺, Cl⁻, HPO₄²⁻ and HCO₃⁻. The anode and cathode catalysts may be in electrode form. Electrolyte solutions may also be acidic (e.g. sulfuric, hydrochloride acids) or basic (e.g. sodium hydroxide, potassium hydroxide.

In one embodiment, a DFAFC described herein may further comprise a housing or a casing. Constructive materials for the housing or the casing include non-conductive polymeric organic materials and are selected from the group consisting of liquid crystal materials, self-assembling materials, polyacrylates, polymethacrylates, poly(C₁-C₁₂ alkyl methacrylates). polyoxy(alkylene methacrylates), poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), thermoplastic polycarbonates, polyesters, polyamide, polyimide, polyurethane, poly(urea)urethane, polythiourethane, polythio(urea)urethane, polycyclic alkene, polyurethanes, poly(ethylene terephthalate), polyolefin, polystyrene, poly(alpha methylstyrene), copoly(styrene-methylmethacrylate), copoly(styrene acrylonitnile), polyvinylbutyral and polymers of members of the group consisting of polyol(allyl carbonate) monomers, polyfunctional acrylate monomers, polyfunctional methacrylate monomers, diethylene glycol dimethacrylate monomers, diisopropenyl benzene monomers, alkoxylated polyhydric alcohol acrylate monomers and diallylidene pentaerythritol monomers, copolymers thereof, and/or mixtures thereof.

Applications of the described DFAFC include small, portable electronic devices such as phones, digital cameras and laptop computers.

An exemplary fuel cell membrane electrode assembly of the invention is linked to a capacitor or other charge storage device so that a sufficiently high potential may be applied from time to time to clean the Pd/Pt catalyst. A portion of the energy generated by an exemplary fuel cell of the invention may be used to charge the capacitor or other storage device over a period of 30 min or so, for example, with the charge from the capacitor then applied to clean the Pd/Pt catalyst.

In one embodiment, the fuel cell described herein may have a stable working temperature of 25-100° C., preferably 25-60° C. Currents of up to 150 mA/cm², preferably 100-130 mA/cm² and power outputs of up to 60.0 mW/cm², preferably 40.0-50.0 mW/cm² may be produced by the fuel at open circuit potentials of 0.60-0.80 V, preferably 0.65-0.72 V.

The examples below are intended to further illustrate protocols for assessing the methods and catalysts described herein, and are not intended to limit the scope of the claims.

### Example 1

### Chemicals

TEOS (Si(OC₂H₅)₄ 99 wt. %), sucrose (C₁₂H₂₂O₁₁, 98 wt. %) were purchased from LOBA Chemical (Pvt) Ltd., Extra pure cerium nitrate hexahydrate (Ce(NO₃)₃.6H₂O), Palladium nitrate dihydrate (Pd(NO₃)₂. 2H₂O, 40 wt. % Pd), hexachloro Platinic acid hexahydrate (H₂(PtCl₆).6H₂O, 40 wt. %), and Sodium borohydrite (NaBH₄) were purchased from MERCK. Hydrofluoric acid (HF, 40 wt. %), sulphuric acid (H₂SO₄, 97-98 wt. %), formic acid (HCOOH, 95 wt. %), ethanol (C₂H₅OH, 99.8 wt. %), hydrochloric acid (HCl, 37 wt. %) and Nation ion Exchange resin (5 wt. % solution in aliphatic alcohols and water) were purchased from Sigma Aldrich. Millipore water was used for the preparation of all aqueous solutions. H₂ in nitrogen (10% vol.), 99.99% pure N₂ and H₂ gases were supplied in cylinders by SiGas.

### Example 2

### Preparation of PdPt/CeO₂-OMC Electrocatalysts

There were three major steps involved in the preparation of electrocatalysts in the present invention. In the first step, SBA-15 was prepared by polymerization of TEOS using hard template method. In the second step, the CeO₂ modified CeO₂-OMC support was synthesized by carbonization of sucrose followed by the hydrofluoric acid (HF) treatment to remove the unconverted silica traces completely. In the third and final step, Pd and Pt were loaded on the CeO₂-OMC support using a borohydride reduction method. The details of the above three steps are presented in the following examples.

### Example 3

### Synthesis of CeO₂-SBA-15

The SBA-5 silica sample was synthesized by a hard-template TEOS polymerization method as reported by Zhao et al. (Dongyuan Z, Jianglin F, Qisheng H, Nicholas M, Glenn H F, Bradley F C, Galen D S., Science 279(1998) 548-552—incorporated herein by reference in its entirety) and Jun et al. (Shinae J, Sang H J, Ryong R, Michal K, Mietek J, Zheng L, Tetsu O and Osamu T., J. Am. Chem. Soc. 122(2000) 10712-10713—incorporated herein by reference in its entirety) with slight variations. The prepared SBA-15 was then modified with CeO₂ by wetness impregnation method using Ce(NO₃)₃.6H₂O as cerium precursor. A Ce(NO₃)₃.6H₂O solution was prepared in deionized water under starring at room temperature for 30 min. The solution was added to desired amount of preheated SBA-15 at 110° C. The resultant suspension was ultra sonicated for 24 h at room temperature and then dried at 100° C. to remove the water completely. Finally, the sample was calcinated at 450° C. under argon flow for 4 h to decompose cerium nitrate salt to cerium oxide.

### Example 4

### Synthesis of Hybrid CeO₂-OMC

CeO₂-OMC was prepared by carbonization of sucrose into mesopores of CeO₂-SBA-15 as reported by Wang et al. (Lifeng Wang, Sen L, Kaifeng L, Chengyang Y, Desheng L, Yan Di, Peiwei F, Dazhen J and Feng S X., Micropor. Mesopor. Mat. 85(2005) 136-142-incorporated herein by reference in its entirety) with some modifications. In this method, 1.0 g of CeO₂-SBA-15 was added to a solution containing 1.25 g of sucrose, 0.14 g of sulfuric acid and 5.0 g of deionized water. The mixture was then placed in an oven at 100° C. for 6 h, after that the oven temperature was increased to 160° C. at a heating rate of 2° C./min. The sample was kept at 160° C. for another 6 h. The above steps were repeated by adding 0.8 g of sucrose in order to fill the internal CeO₂-SBA-15 silica pores completely. The resultant material was pyrolyzed at 800° C. under N₂ flow for 6 h to obtain the carbon-silica composite. The composite was washed with 5 wt. % HF solution to remove the silica template. Finally, the sample was filtered, washed with deionized water and dried at 100° C. for 4 h. Later on TGA analysis confirmed the high temperature (25-400° C.) stability of support material.

### Example 5

### Preparation of PdPt/CeO₂-OMC Electrocatalysts

Bimetallic PdPt/CeO₂-OMC electrocatalysts were prepared by borohydride reduction method using NaBH₄ as a reducing agent. In this technique, required amount of metal salts (Palladium nitrate and hexachloro Platinic acid), were drop wise added to CeO₂-OMC support under constant, vigorous stirring. The metal loaded CeO₂-OMC support was then added to 200 ml deionized water and stirred it for 3 h to make a homogeneous suspension. Appropriate amount of sodium citrate solution was added to the suspension with vigorous stirring and allowed for further 1 h ultrasonication. Freshly prepared 120 mg (3 times molar ratio of active metals) NaBH₄ solution was slowly added to the suspension and set for another 12 h stirring to allow complete reduction of Pd and Pt salts at room temperature. The slurry was then centrifuged, washed with deionized water and dried at 110° C. for 4 h. In the final samples, total metal loading was 20 wt. % and the mass ratio of Pd to Pt was easily adjusted by using different amounts of Pd and Pt precursors.

### Example 6

### Physical Characterizations of the Catalysts

Specific surface areas (BET) and pore volume of the synthesized materials/catalysts were determined by N₂ adsorption analysis using a Micromeritics model ASAP 2010 analyzer. Prior to the measurements, the samples were degassed at 250° C. under nitrogen flow for 6 h in order to remove moisture completely. Physical adsorption of N₂ was carried out in a liquid nitrogen bath maintaining 77 K temperature.

The XRD analysis was conducted to detect the crystalline phases of catalysts and measure their sizes. The XRD experiments were carried out using a Smart Lab (9 kW) Rigaku XRD X-ray diffraction X-ray diffracto meter, with a diffraction angle range 2θ=5-80° using Cu Kα radiation with a scan rate of 6° min⁻¹.

The morphologies of the support and catalysts were studied by using a scanning electron microscope (JEOL JSM-6460LV) operated at 20 kV equipped with energy dispersive X-ray (EDX). EDX was carried to find out the composition of catalyst samples.

Transmission electron microscopy (TEM) images were taken to determine the metal dispersion on support material along with particle size of loaded metal. An ultra-high resolution FETEM (JEOL, JEM-2100F) at an accelerating voltage of 200 kV was employed to capture the images of the solid samples.

TGA was recorded on a Shimadzu TGA-60 between 25° C. and 800° C. at the default ramp rate of 10° C./min under dry air atmosphere for determination of oxidation temperature of support material.

### Example 7

### XRD Analysis

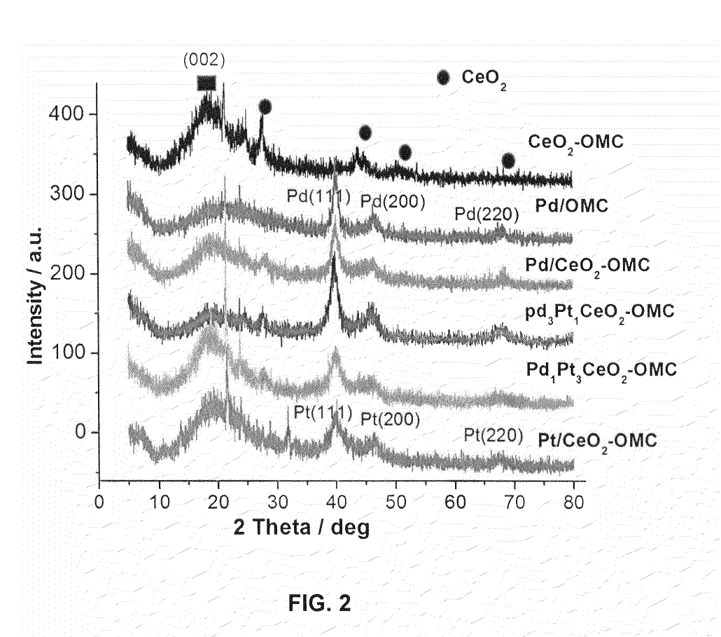

The XRD analysis was conducted to detect the crystalline structure of the prepared sample composites. FIG. 2 shows the XRD patterns of Pd/OMC, Pd/CeO₂-OMC, Pt/CeO₂-OMC, and PdPt/CeO₂-OMC catalysts with various Pd to Pt ratios. Catalysts with Pd to Pt ratios are denoted as Pd₃Pt₁/CeO₂-OMC and Pd₁Pt₃/CeO₂-OMC. In all samples, diffraction peak (19.18°) at 2θ corresponds to the (002) planes of the carbon support (Yang L Jun, Su Neng, Ting and Shi Jun, Sci China Chem. 55(2012) 391-397—incorporated herein by reference in its entirety). As can be seen from FIG. 2, the XRD patterns of both Pd and Pt are quite similar. For Pd/OMC, Pd/CeO₂-OMC and PtPd/CeO₂-OMC catalysts, the peaks at 40.4°, 47° and 68° correspond to the (111), (200) and (220) planes of Pd, respectively, indicating the characteristics of face-centered cubic (fcc) crystalline structure of palladium nanoparticle's (JCPDS, Card No. 65-6174). The XRD patterns of both the CeO₂-OMC and OMC supported catalysts shows that the support modification and decreasing Pd content ratio has no prominent effects on diffraction peaks except making it broader and slightly moving the peaks to lower angle. In Pt/CeO₂-OMC catalyst, the XRD patterns showed similar Pt diffraction peaks at 400, 46.70 and 68° angles corresponds to (111), (200) and (220), respectively. These observations are in line with what has been also reported by Z. P. Sun et al. (Zhi-Peng Sun, Xiao G Z, Hao Tong, Yan Y L, Hu L L., J. Colloid and Interf. Sci. 337(2009) 614-618—incorporated herein by reference in its entirety).

Cerium oxide peaks appeared at 27.6°, 44°, 53° and 69.7° places, indexed to fcc-phase of ceria (JCPDS no. 34-0394) (Sun C W, Xie Z, Xia C R, Li H, Chen L Q., Electrochem. Commun. 8(2006) 833-83—incorporated herein by reference in its entirety) and their diffraction peaks intensity are too weak to be useful for the calculation of cerium crystalline size. The crystalline size of Pd and Pt was calculated using Sherrer Equation for Pd/Pt (111) peak (Juqin Zeng, Carlotta F, Mihaela A. D, Alessandro H. A. M V, Vijaykumar S. I, Stefania S, and Paolo S., Ind. Engg. Chem. Res. 51(2012) 7500-7509—incorporated herein by reference in its entirety).

$$d = \frac{0.9 λ}{( β Cos θ )}$$

Where d is the average particle size, λ is the X-ray wave length 0.154 nm, θ is the diffraction angle of the Pd (111) peak and β is the peak broadening (FWHM). The crystalline size obtained for Pd/OMC, Pd/CeO₂-OMC, Pd₃Pt₁/CeO₂-OMC, Pd₁Pt₃/CeO₂-OMC and Pt/CeO₂-OMC was found to be 6.5 nm, 6.2 nm, 5.8 nm, 4.8 nm and 4.3 nm respectively. It was noticed that the crystalline size of samples decreased with the increase of Pt to Pd ratio in the catalyst.

### Example 8

### TEM Analysis

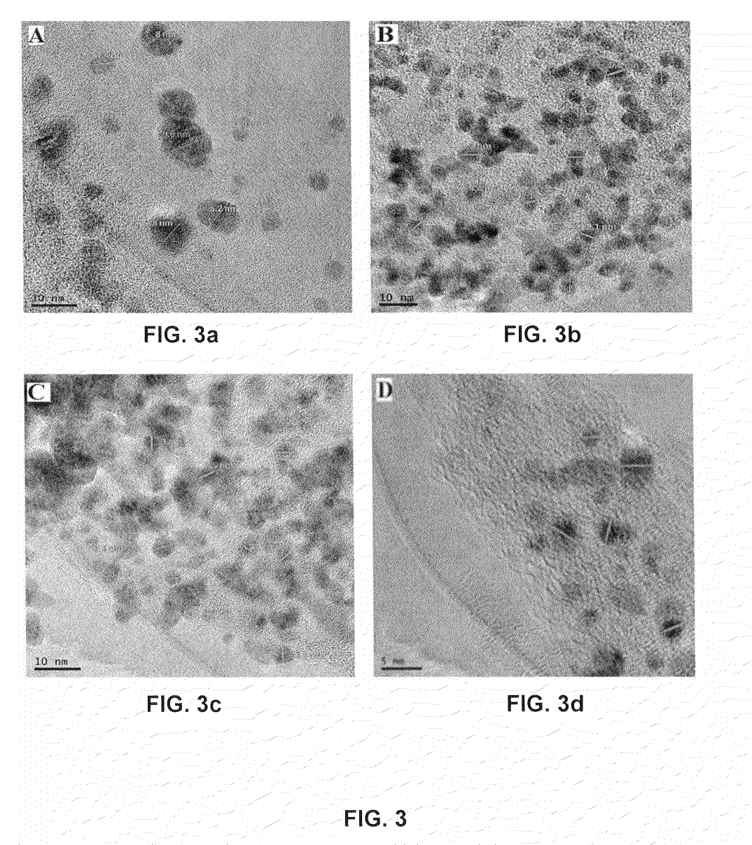

Particle size and uniform dispersion of metal particles on support surface strongly affects the characteristics of catalysts. Referring to the TEM images in FIGS. 3a-3d, it can be seen from FIG. 3a that most of Pd nanoparticles are uniformly dispersed on the surface of CeO₂-OMC support and no agglomeration was detected on the surface. As shown in FIGS. 3b and 3c, both the modification of the OMC with CeO₂ and increase of Pd to Pt ratios influence the helps forming smaller size crystals on the surface. This dispersion on those catalysts also seemed more ordered. The pure Pt nanocrystal size distribution is shown in FIG. 3d. The average crystal size of Pd/CeO₂-OMC (FIG. 3a), Pd₃Pt₁/CeO₂-OMC (FIG. 2b), Pd₁Pt₃/CeO₂-OMC (FIG. 3c) and Pt/CeO₂-OMC (FIG. 3d) catalysts are found to be 4.82 nm, 3.3 nm, 3.1 nm and 2.3 nm, respectively. The measured crystal sizes are in congruence with the values as calculated from Sherrer's Equation using XRD data.

### Example 9

### SEM-EDX Analysis

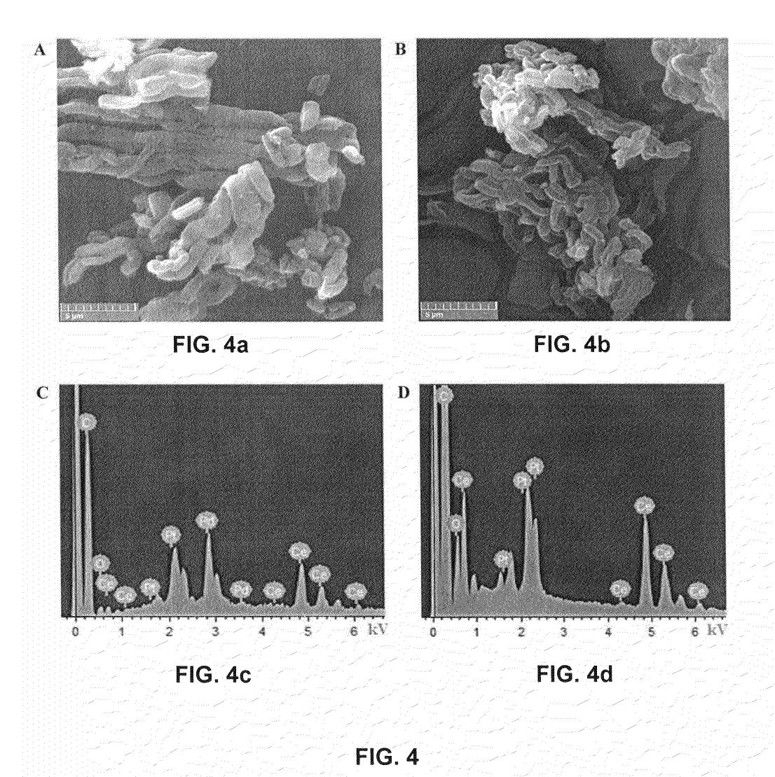

The morphology of the OMC support and electrocatalysts, as synthesized, was evaluated using scanning electron microscopy. As shown in the SEM image of FIG. 4a, the OMC support retained aggregated rope-like structure with smooth surfaces having broad interconnection between the ropes. The length of rope is estimated to be around 4-8μm (Lifeng Wang, Sen L, Kaifeng L, Chengyang Y, Desheng L, Yan Di, Peiwei F, Dazhen J and Feng S X., Micropor. Mesopor. Mat. 85(2005) 136-14—incorporated herein by reference in its entirety). The SEM image of Pd₃Pt₁/CeO₂-OMC in FIG. 3b shows the uniform loading of metal particles on support. The metal crystal sizes also appeared to be narrowly distributed. Within the resolution level of SEM, it is not possible to differentiate any significant changes in shape between support and catalyst material except length of rope reduced to 3-5μm in FIG. 4b.

The EDX images of Pd₁Pt₃/CeO₂-OMC (FIG. 4c) and Pt/CeO₂-OMC samples (FIG. 4d) reveal the presence of carbon, cerium and other respective metals (Pt, Pd). The initial unknown peak represents the aluminum holder which is used in JEOL JSM-6460LV machine. The presence of metal elements such as Pd, Pt and Ce reveals the successful deposition of metals on mesoporous carbon. The compositions of Pd, Pt and Ce in all catalyst samples are shown in Table 1.

TABLE 1
Surface properties of OMC and CeO₂-OMC & catalysts samples

| | Weight % | | | S_{BET} | d_{BJH} | Vₜₒₜₐₗ |
|---|---|---|---|---|---|---|
| Sample | Pd % | Pt % | Ce % | (m²g⁻¹) | (nm) | (cm³g⁻¹) |
| OMC | — | — | — | 1005 | 3.82 | 1.23 |
| CeO₂-OMC | — | — | 8.31 | 1119 | 3.44 | 1.24 |
| Pd/CeO₂-OMC | 6.49 | — | 8.07 | 595 | 3.49 | 0.68 |
| Pd₃Pt₁/CeO₂-OMC | 13.27 | 9.34 | 8.49 | 592 | 3.54 | 0.66 |
| Pd₁Pt₃/CeO₂-OMC | 7.81 | 7.93 | 7.26 | 646 | 3.51 | 0.68 |
| Pt/CeO₂-OMC | — | 11.81 | 8.12 | 697 | 3.48 | 0.67 |

### Example 10

### TGA Analysis

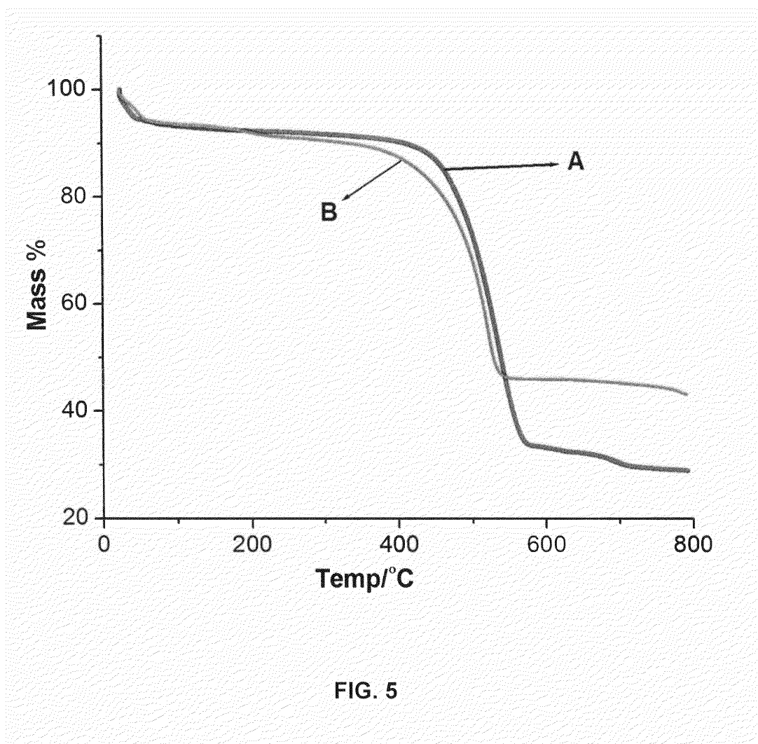

TGA measurements of CeO₂-OMC and Pd₃Pt₁/CeO₂-OMC catalysts in dry air atmosphere are shown in FIG. 5. The temperature range was selected as 25° C. to 800° C. for complete combustion of mesoporous carbon support (Zhao H T, Gang W, Bing W and Ying G., J. Power Sources 164(2007) 105-110—incorporated herein by reference in its entirety). The TGA profiles show the thermal stability of OMC between 25° C. to 420° C. Initial mass reduction was the result of moisture evaporation, present in the samples. Quick weight loss at temperature between 470° C. to 560° C. for CeO₂-OMC support and from 420° C. to 565° C. for Pd₃Pt₁/CeO₂-OMC catalyst were recorded. This loss was due to the fast oxidation of OMC. TGA analysis also indicates the steady weight loss of mesoporous carbon which was according to the carbon fraction added in samples. The amount greater than 20% in catalysts showed the oxides formation of PtPd catalyst which may cause at 800° C. (Yang L Jun, Su Neng, Ting and Shi Jun, Sci China Chem. 55(2012) 391-397—incorporated herein by reference in its entirety). These observations confirm that actual and expected compositions are quite consistent.

### Example 11

### N₂ Adsorption Isotherms

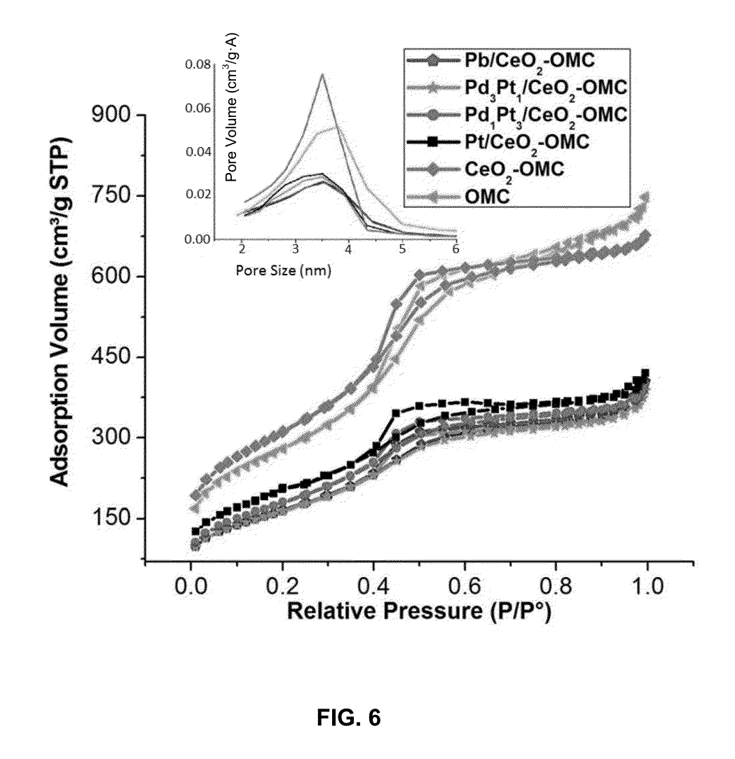

FIG. 6 shows the N₂ adsorption-desorption isotherms and corresponding BJH (Barret-Joyner-Halenda) pore size distribution curves of the OMC, CeO₂ modified OMC and the prepared catalyst samples. Monolayer-multilayer adsorption, a capillary condensation, and a multilayer adsorption on the outer particles surface are the three phases which can be distinguished from the figure in all samples. OMC and the CeO₂-OMC samples exhibited a type IV isotherm with a slightly sharp capillary condensation step between p/p₀=0.42 and 0.95. This lower pressure capillary condensation indicates that OMC and CeO₂-OMC support contains smaller average pore sizes. BET surface area, pore size and total volume of OMC and PdPt based catalysts were calculated from the nitrogen adsorption isotherm data and summarized in Table 1. The measured BET surface area of OMC 1005 m²/g is in agreement with material as reported by J. Zeng et al. (2013) (J. Zeng, C. Francia, C. Gerbaldi, V. Baglio, S. Specchia, A. S. Aricò, P. Spinelli., Electrochim. Acta 94(2013) 80-91—incorporated herein by reference in its entirety). The BET surface area of the CeO₂ modified CeO₂-OMC support is 1119 m²/g which is 1.12 times higher than that of the unmodified support material. The total pre volume of CeO₂-OMC support remains almost same as the total pore volume of OMC support. The BJH pore size for OMC and CeO₂-OMC is measured as 3.8 nm and 3.4 nm, respectively. These observations suggest that the characteristics surface area and other properties of OMC have significantly improved by the addition of cerium. From BJH, pore size distribution curve it is quite clear that pore size of all sample is very consistent and is between 3 and 4 nm.

### Example 12

### Electrochemical Characterizations of the Catalysts

The electrochemical oxidation of formic acid was performed using a Biologic potentiostat (VMP3 Biologic Science Instruments, France.) at ambient temperature in a three electrode cell. A glassy carbon (3 mm diameter) covered with a thin layer of Nafion-impregnated catalyst (geometrical area of the electrode: 0.076 cm²) was used as the working electrode. A Pt-wire and an Ag/AgCl electrode (3.5 M KCl) were used as the counter and reference electrodes, respectively. All potentials reported as quoted versus the Ag/AgCl reference. At first 5 mg of electrocatalyst was dispersed in 1 mL of ethanol, 30μL Nafion/aliphatic and water solution (5 wt. % Nafion) by sonication for 30 min to form a catalyst ink. 10μL of this ink was transferred (by pipette) to the polished surface (Aluminum powder of 0.3μ and 0.5μ) of the glassy carbon. For all the experiments the metal loading on the working electrode was maintained at 0.127 mg metal/cm². CV data were recorded from −0.2 to 1.2 V (vs. Ag/AgCl) at a scan rate of 20 mV/s in 0.5 M H₂SO₄ solution with and without 0.5 M HCOOH. Chronoamperometry (CA) at 0.3 V (vs. Ag/AgCl) in N₂-saturated 0.5 M H₂SO₄ with 0.5 M CHOOH was also recorded.

Electrochemical active surface area (ECAS) and CO poisoning tolerance of catalyst samples were demonstrated by CO stripping voltammetry. In stripping voltammogram, CO was bubbled through 0.5 M H₂SO₄ electrolyte solution for 30 min, keeping working electrode in the cell under constant applied electrode potential of 0.2 V. After purging by N₂ gas for 20 min to aerate the dissolved CO, CO stripping voltammograms were recorded from −0.2 to 1.2 V (vs. Ag/AgCl) at a scan rate of 20 mVs⁻¹ to ensure the complete oxidation of CO_{ads}. Finally, ECAS were calculated using 0.42 mC/cm² for CO_{ads} monolayer (Andrzej Czerwiński, Electroanal. Chem. 379(1994) 487-493; Hyun J K, Won 1 K, Tae J P, Hyung S P and Dong J S., Carbon 46(2008) 1393-1400; Ing. habil. Kai Sundmacher, Mihai Christov, habil. Helmut WeiB, Kinetics of Methanol Electrooxidation on PtRu Catalysts in a Membrane Electrode Assembly, 2005, page 27 each incorporated herein by reference in its entirety).

### Example 13

### CO Stripping Analysis

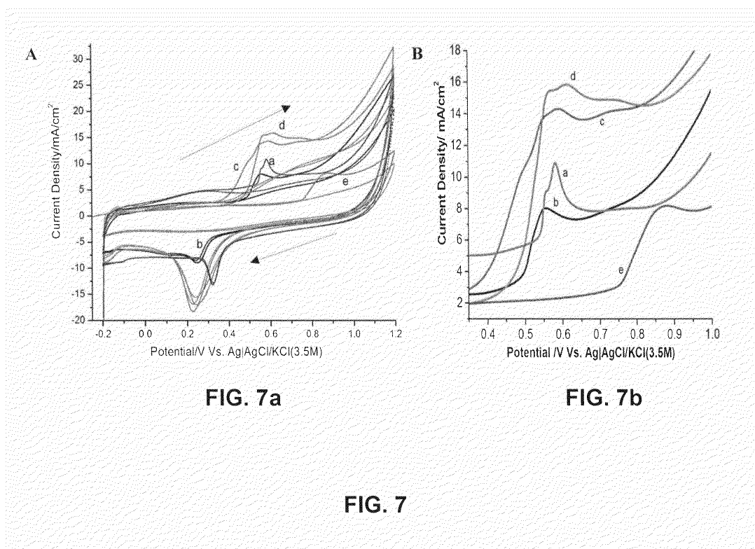

CO stripping voltammetry was performed to demonstrate the CO poisoning resistance of PdPt based electrocatalysts. FIGS. 7a and 7b show the kinetics and onset potential of CO oxidation on the surface of electrocatalysts. In FIG. 6a, the first voltammogram represents Pd/OMC catalyst, which shows only one peak at 580 mV with the onset potential about 505 mV. The scan potential peak of Pd/CeO₂-OMC catalyst is around at 550 mV. However, the addition of CeO₂ the onset potential is negatively shifted by 65 mV and is seen at 440 mV. By increasing Pt-contents, peak potential shows a positive shift and moves towards higher potential. For Pd₃Pt₁/CeO₂-OMC catalyst the onset potential first decreases to 400 mV and then positively increases for higher Pt-content catalysts. The relatively higher values of peak and onset potentials of Pt/CeO₂-OMC catalyst is possibly due to the poisoning of Pt surface in which no reactive sites are available for hydrogen oxidation. Table 2 summarizes the CO stripping intensity, peak and onset potentials for all the studied catalysts. The intensity of CO oxidation peaks is varied with the variation of Pt contents. For Pd₃Pt₁/CeO₂-OMC catalyst, intensity of CO peak is about 13.6 mA/cm² which is remarkably higher than that of Pd/CeO₂-OMC (7.8 mA/cm²) but is smaller than Pd_{I}Pt₃/CeO₂-OMC catalyst (15.5 mA/cm²). Catalysts with lower onset potential are found to be better in catalytic activity for CO oxidation. Accordingly, Pd₃Pt₁/CeO₂-OMC electrocatalyst is more CO tolerant than the other catalysts with higher Pt contents. Table 2 also lists electrochemical active surface area (ECAS) of Pt and Pd calculated by using 0.42 mC/cm² (Hyun J K, Won 1 K, Tae J P, Hyung S P and Dong J S., Carbon 46(2008) 1393-1400; Ing. habil. Kai Sundmacher, Mihai Christov, habil. Helmut Weiβ, Kinetics of Methanol Electrooxidation on PtRu Catalysts in a Membrane Electrode Assembly, 2005, page 27—each incorporated herein by reference in its entirety), as charge associated to the monolayer on Pt and Pd nanoparticles. The Pd₃Pt₁/CeO₂-OMC catalyst shows highest ECAS values (48.7 m²/g metal) as compared to the all other catalyst studied. The high ECAS value further indicates that the bimetallic Pd₃Pt₁/CeO₂-OMC catalyst is a potential CO tolerance catalyst.

TABLE 2
Electrochemical properties of catalysts on CO oxidation.

| | Area of | | | | |
|---|---|---|---|---|---|
| | desorbed | CO Stripping | | ECAS^{a} | Peak |
| | CO peak | Eₒₙₛₑₜ (mV) | | (m²/g | Intensity |
| Catalyst | (mC/cm²) | (mV) | Eₚₑₐₖ | metal) | (mA/cm²) |
| Pd/OMC | 8.7 | 505 | 580 | 16.3 | 11 |
| Pd/CeO₂-OMC | 8.6 | 440 | 550 | 16.1 | 7.8 |
| Pd₃Pt₁/CeO₂-OMC | 25.93 | 400 | 585 | 48.7 | 13.6 |
| Pd₁Pt₃/CeO₂-OMC | 21.7 | 430 | 620 | 40.6 | 15.5 |
| Pt/CeO₂-OMC | 16.24 | 750 | 860 | 30.4 | 8.2 |

${}_{}^{a}{ECAS}{}_{CO}^{} = \frac{θc}{w * 0.42} , θc = mC \text{/} {cm}^{2} , w = 0.127 mg \text{/} {cm}^{2} , 0.42 mC \text{/} {cm}^{2}$

### Example 14

### Cyclic Voltammetry Analysis

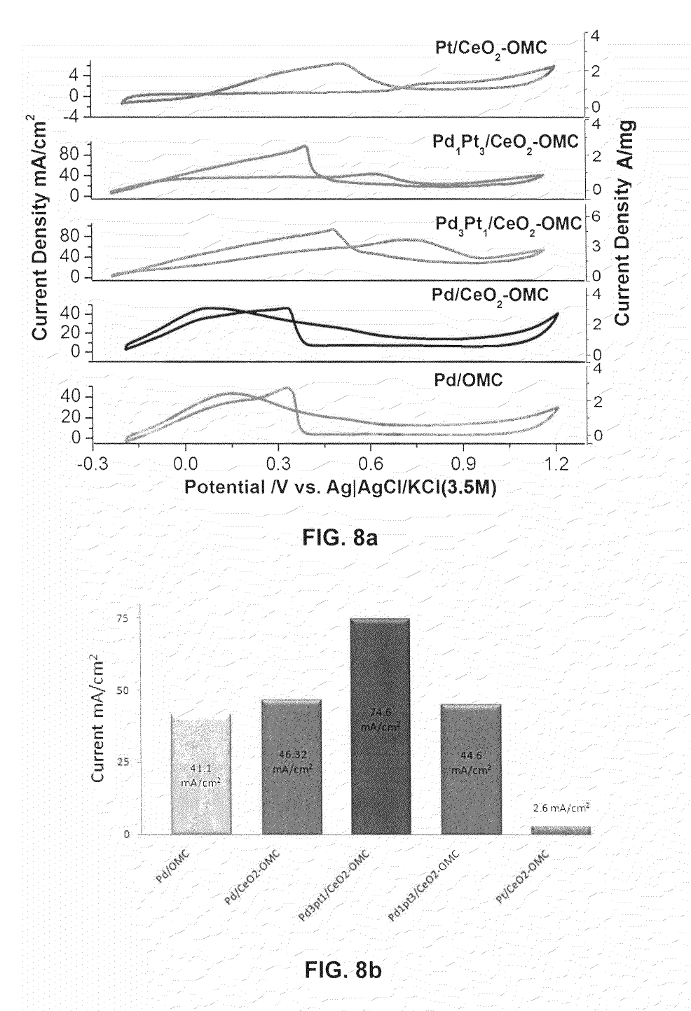

The formic acid oxidation activity of the CeO₂ modified electrocatalysts was established by CV (scan rate of 20 mV/s) in 0.5 M HCOOH and 0.5 M H₂SO₄ solution. Prior to the measurements, the electrolyte solution and electrodes were purged with N₂ for 20 min to deaerate the system and to attain the steady state. The CV analysis of all the catalysts is presented in FIG. 8a while FIG. 8b plots the maximum current for each catalyst. From FIGS. 8a and 8b, it can be observed that both intensities and peak potential of PtPd/CeO₂-OMC catalysts are changing with Pd to Pt ratios. At peak potential of 70 mV, oxidation current density of Pd/CeO₂-OMC catalyst is around 46.32 mA/cm² (3.24 A/mg) which is about 5 mA/cm² higher than that of Pd/OMC (41.1 mA/cm²) catalyst. This improved catalytic performance of Pd/CeO₂-OMC is due to better dispersion of noble metals on the CeO₂-modified OMC as observed in SEM and TEM analysis. Furthermore, the current density of Pd/CeO₂-OMC is much greater than that of previously reported commercially available carbon supports with Pd (Yang L Jun, Su Neng, Ting and Shi Jun, Sci China Chem. 55(2012) 391-397; Feng, L G; Yang, J; Hu, Y; Zhu, J B; Liu, C P Xing, W., Int. J. Hydrogen Energ. 37(2012) 4812-4818; Yu Zhu, Yongyin K, Zhiqing Z, Qun Z, Junwei Z, Baojia X and Hui Y., Electrochem. Commun. 10(2008) 802-805; Xiao M Wang, Yong Y X., Electrochim. Acta 54(2009) 7525-7530; Jun Y, Chungui T, Lei and Honggang F., J. Mater. Chem. 21(2011) 3384-3390; Yizhong Lu and Wei C, J. Phys. Chem. C 114 (2010) 21190-21200—each incorporated herein by reference in its entirety). As shown in FIG. 8b, the current density of Pd₃Pt₁/CeO₂-OMC catalyst for anodic scan is 74.6 mA/cm² which is 1.8, 1.61, 1.67 and 28.3 times higher than that of Pd/OMC, Pd/CeO₂-OMC, Pd₁Pt₃/CeO₂-OMC (44.6 mA/cm²) and Pt/CeO₂-OMC (2.6 mA/cm²) catalysts, respectively. The peak potential of Pd₃Pt₁/CeO₂-OMC catalyst is also shifted positively as compared to the Pd/OMC, Pd/CeO₂-OMC and Pd₁Pt₃/CeO₂-OMC catalysts. It can be interpreted that the formic acid electro-oxidation on the two Pd/OMC and Pd/CeO₂-OMC catalysts are much easier. However, due to large ECAS (reported in Table 2) and smaller crystal size of Pt, electrochemical oxidation of formic acid was enhanced for Pd₃Pt₁/CeO₂-OMC catalyst (Yang L Jun, Su Neng, Ting and Shi Jun, Sci China Chem. 55(2012) 391-397—incorporated herein by reference in its entirety). Especially, with the decrease of particle size and Pd content ratio, the peak potential for formic acid electro oxidation shifted positively.

Moreover, the oxidation peak of Pt/CeO₂-OMC catalyst at 790 mV is ascribed to go through a multiple steps or indirect oxidation pathway; CO species are intermediates which strongly adsorbed on the surface of the catalysts. Due to the poisoning effects on Pt surface oxidation current intensity reduced to 2.6 mA/cm² (Haan J L, Masel R I, Electrochim. Acta 54(2009) 4073-4078—incorporated herein by reference in its entirety), while in Pd/OMC, formic acid oxidation goes through a direct oxidation pathway (Wang J, Yin G, Chen Y, Li R, Sun X, Int. J. Hydrogen Energ 34 (2009) 8270-827—incorporated herein by reference in its entirety).

Form the above observation it may be concluded that the modification of OMC with CeO₂ helps improving the peak current density (1.6 times higher than OMC), which positively affects the current activity of PdPt electrocatalysts. Also, the peak potential of Pd₃Pt₁/CeO₂-OMC catalyst was shifted positively ca. 467 mV but it did not largely affect on catalytic activity of catalyst towards formic acid oxidation.

### Example 15

### Chronoamperometry Analysis

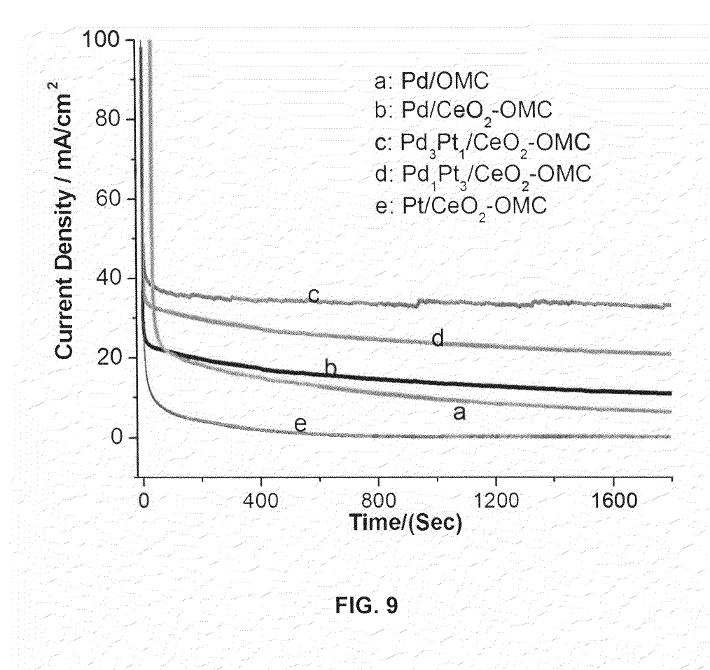

FIG. 9 displays the current density-time response curves during the formic acid oxidation (in the presence of various electrocatalysts) at 0.3 V fixed potential in a solution of 0.5 M HCOOH and 0.5 M H₂SO₄ at 25° C. In all the catalysts, initially a rapid fall in current density was observed. After that the current decreased smoothly and finally reached a steady state at 1800 s. The activity of Pd₃Pt₁/CeO₂-OMC electrocatalyst for formic acid oxidation was higher than the activities using Pd/OMC and PdPt/CeO₂-OMC electrocatalysts. The steady state current density recorded on Pd₃Pt₁/CeO₂-OMC catalyst was about 32.8 mA/cm² which was 5.2 times higher than the steady state current density with Pd/OMC (6.2 mA/cm²) catalyst. Current densities for Pd/CeO₂-OMC, Pd₁Pt₃/CeO₂-OMC and Pt/CeO₂-OMC catalysts were 11 mA/cm², 20.3 mA/cm² and 0.46 mA/cm², respectively. From these results it is confirmed that CeO₂ based electrocatalyst showed somewhat high performance and particularly Pd₃Pt₁/CeO₂-OMC catalyst exhibit high catalytic activity and stability towards HCOOH electro-oxidation.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An electrocatalyst for a fuel cell electrode comprising:
nanoparticles of Pd as a first catalytic metal;
nanoparticles of Pt as a second catalytic metal; and
a catalyst support material comprising nanoparticles of an ordered mesoporous carbon and nanoparticles of CeO₂;
wherein Pd and Pt are present in a ratio of x:y and x>y; and
wherein Pd and Pt are disposed in the mesopores of the mesoporous carbon.

2. The electrocatalyst of claim 1, wherein x and y are independently 1, 2, 3, 4 or 5.

3. The electrocatalyst of claim 1, wherein the electrocatalyst catalyzes the oxidation of formic acid into CO₂.

4. The electrocatalyst of claim 1, wherein Pd and Pt are present in an amount of no greater than 25% of the total weight of the electrocatalyst.

5. A direct formic acid fuel cell comprising:
an anode comprising a catalyst comprising nanoparticles of an ordered mesoporous carbon, CeO₂, Pd, Pt or both;
a cathode;
a proton exchange membrane electrolyte disposed between the anode and the cathode;
a formic acid solution in contact with the anode; and
a solution comprising at least one oxidizing agent in contact with the cathode.

6. The formic acid fuel cell of claim 5, wherein Pd and Pt are present in a ratio of x:y, wherein x and y are independently 1, 2 or 3.

7. The formic acid fuel cell of claim 5, wherein the amount of Pd is no greater than 13% of the total weight of the catalyst.

8. The formic acid fuel cell of claim 5, wherein the amount of Pt is no greater than 12% of the total weight of the catalyst.

9. The formic acid fuel cell of claim 5, wherein the amount of ordered mesoporous carbon is 75-85% of the total weight of the catalyst.

10. The formic acid fuel cell of claim 5, wherein the amount of Ce is 7-10% of the total weight of the catalyst.

11. The formic acid fuel cell of claim 5, wherein the ordered mesoporous carbon has a BET specific surface area of at least 1000 m² g⁻¹.

12. The formic acid fuel cell of claim 5, wherein the ordered mesoporous carbon has a pore size of no greater than 4 nm.

13. The formic acid fuel cell of claim 5, wherein the ordered mesoporous carbon has a pore volume of 1.0-1.5 cm³ g⁻¹.

14. The formic acid fuel cell of claim 5, wherein the Pd and Pt particles are no greater than 5 nm.
